(19) United States
(12) Patent Application Publication
(10) Pub. No.: US 2014/0117675 A1
(43) Pub. Date: May 1, 2014

(54) REMOVABLE ENCLOSURE FOR A TOWABLE GENERATOR

(71) Applicant: KOHLER CO., Kohler, WI (US)

(72) Inventors: Curtis D. Knight, Milwaukee, WI (US); Joshua Ziebert, Fond du Lac, WI (US); Justin D. Keske, Elkhart Lake, WI (US); Dawn Vertz, Sheboygan, WI (US); Aaron Kuhlow, Howards Grove, WI (US); Ken Hall, Manitowoc, WI (US)

(73) Assignee: Kohler Co., Kohler, WI (US)

(21) Appl. No.: 13/659,958

(22) Filed: Oct. 25, 2012

(51) Int. Cl. H02K 7/18

(52) U.S. Cl. 290/1 A

(57) ABSTRACT

The towable power generation system includes an internal combustion engine and an alternator driven by the internal combustion engine to generate electrical power. The towable power generation system further includes a trailer configured to be attached to a vehicle that is adapted to tow the trailer. A base (e.g., a skid) is attached to the trailer such that the internal combustion engine and the alternator are mounted on the base. The trailer includes one or more axles, wheels, a frame and a tongue for attaching the trailer to a towing vehicle. An enclosure houses the internal combustion engine and the alternator. The enclosure is detachably connected to the base using fasteners such that when the fasteners are removed only the enclosure is removed from the base and every other part of the towable generator system remains in place.

### TECHNICAL FIELD

Embodiments pertain to a towable generator, and more particularly to towable generator with a removable enclosure.

### BACKGROUND

Existing towable generators are typically used to provide temporary power at remote locations. As examples, such towable generators may be used to provide power at construction sites, emergency response sites or other locations that do not have ready access to utility power.

The generators are typically mounted on a trailer in order to move the towable generator from/to a remote location. Conventional towable generators include some form of electric generator.

One common type of electric generator includes an internal combustion engine that drives an electrical alternator to produce alternating electricity. The internal combustion engine and the electrical alternator are typically housed inside an enclosure that protects the internal combustion engine and the electrical alternator from the environment where the towable generator is located (or traveling through).

One of the drawbacks with existing towable generators relates to the enclosures that house the internal combustion engine and the electrical alternator. The enclosures are often difficult to remove. In addition, usually only portions of the enclosure are available for removal, which prohibit/inhibits access to portions of the internal combustion engine and/or the electrical alternator for repair or replacement.

Therefore, a need exists for a towable generator that includes an enclosure that is easily removable from the rest of towable generator. The enclosure of the towable generator should also be removed without extensive disassembly of other components that form the towable generator.

### BRIEF DESCRIPTION OF THE DRAWINGS

FIG. 1 is a side view illustrating an example towable power generation system.

FIG. 2 is a side view of the example towable power generation system shown in FIG. 1 where an enclosure is opened to expose the components inside the enclosure.

FIG. 3 is an exploded side view of the example towable power generation system shown in FIG. 1.

FIG. 4 is a perspective view illustrating the example towable power generation system shown in FIG. 1.

FIG. 5 is a perspective view of the example towable power generation system shown in FIG. 4 where the enclosure is opened to expose the components inside the enclosure.

FIG. 6 is an exploded perspective view of the example towable power generation system shown in FIG. 4.

FIGS. 7-8 are top views of the example towable power generation system shown in FIGS. 1 and 4 where the enclosure is removed from the rest of example towable power generation system.

### DETAILED DESCRIPTION

The following description and the drawings sufficiently illustrate specific embodiments to enable those skilled in the art to practice them. Other embodiments may incorporate structural, logical, electrical, process, and other changes. Portions and features of some embodiments may be included in, or substituted for, those of other embodiments. Embodiments set forth in the claims encompass all available equivalents of those claims.

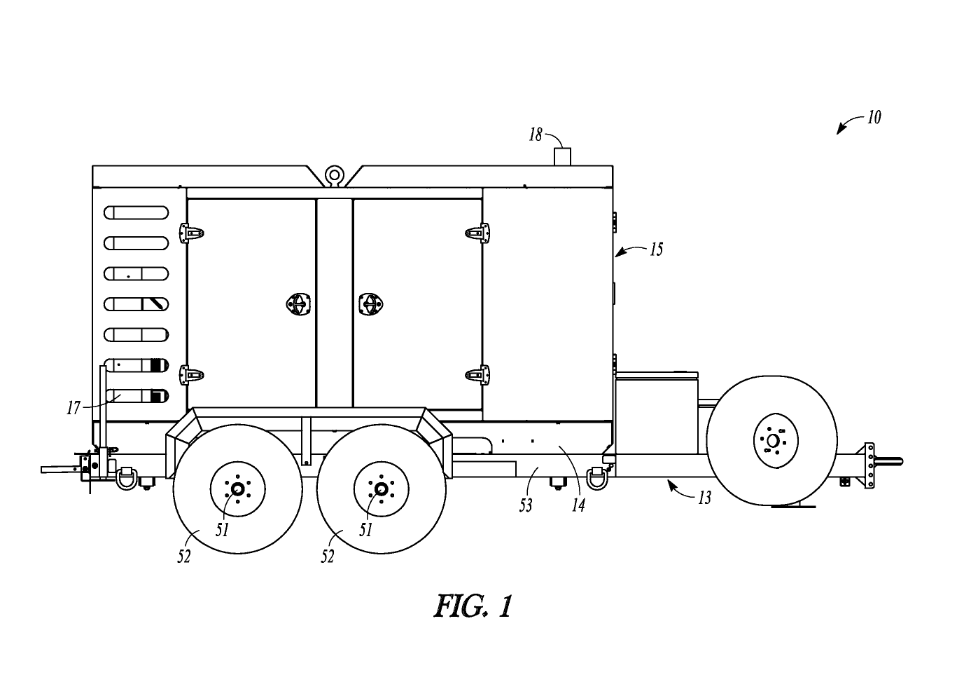

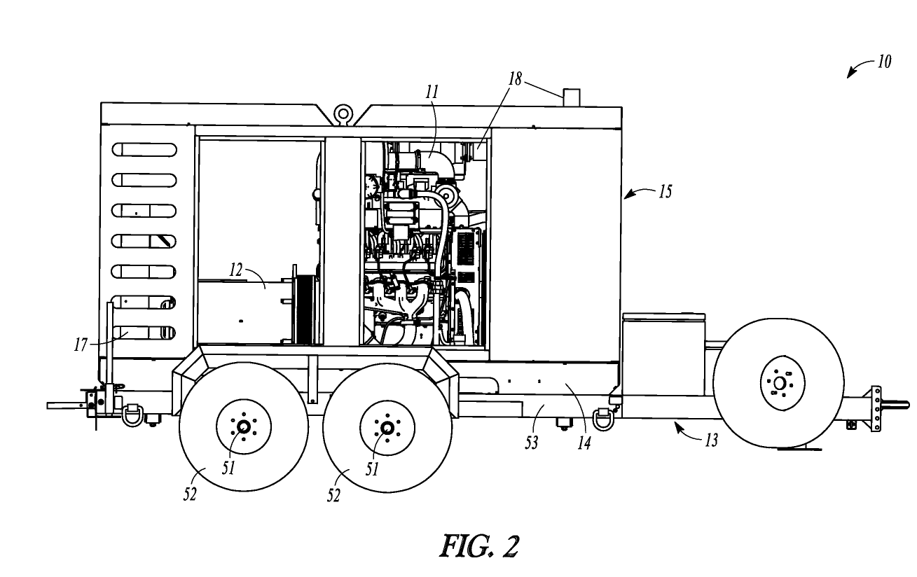

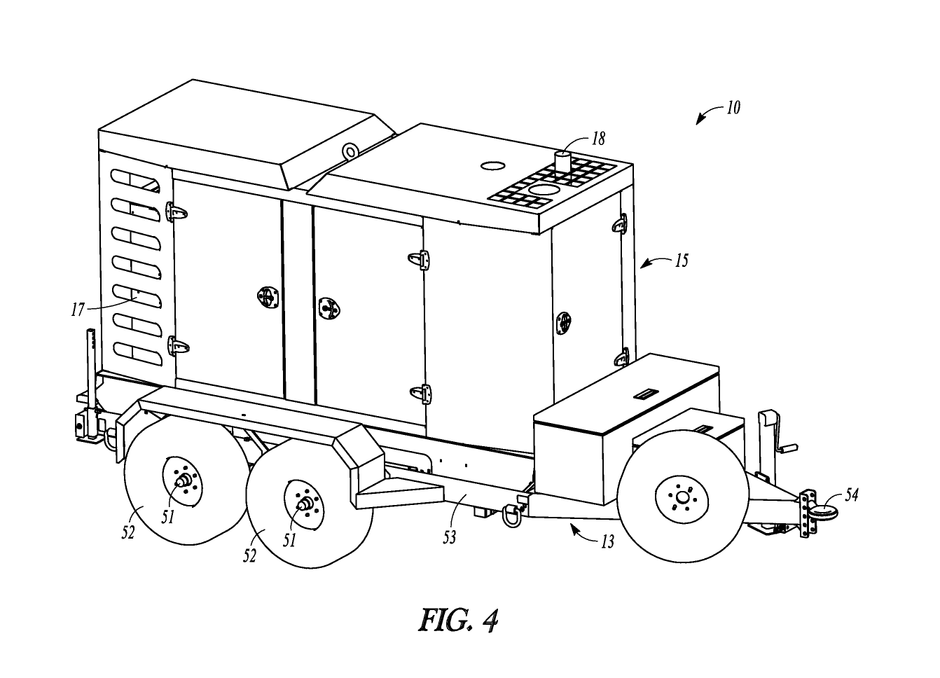

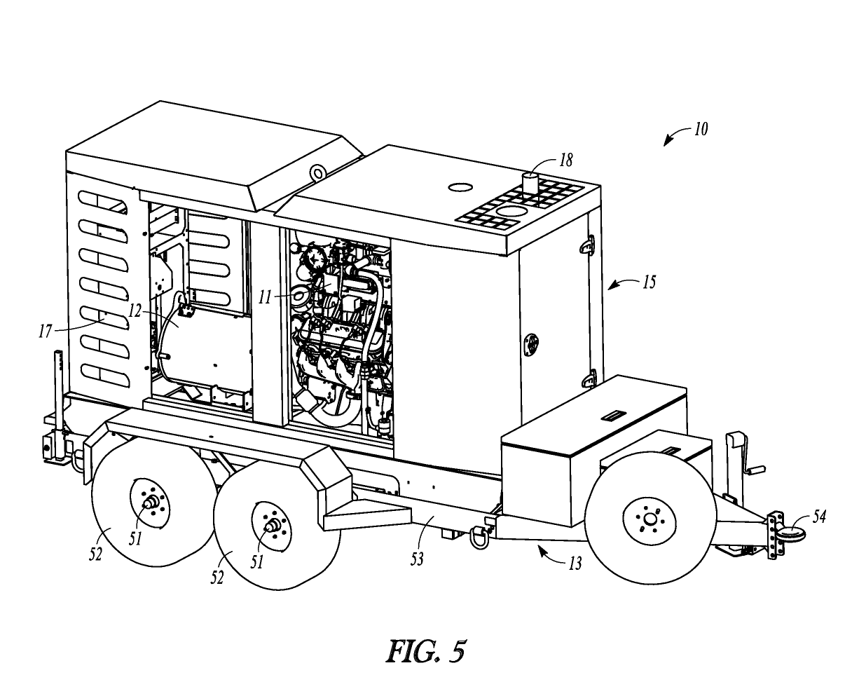

FIGS. 1-6 illustrate an example towable power generation system 10. The towable power generation system 10 includes an internal combustion engine 11 (see FIGS. 2, 3, 5 and 6) and an alternator 12 (see FIGS. 2, 3, 5 and 6) driven by the internal combustion engine 11 to generate electrical power.

The towable power generation system 10 further includes a trailer 13 configured to be attached to a vehicle (not shown) that is adapted to tow the trailer 13. A base 14 (e.g., a skid) is attached to the trailer 13 such that the internal combustion engine 11 and the alternator 12 are mounted on the base 14. In the illustrated example embodiments, the trailer includes one or more axles 51, wheels 52, a frame 53 and a tongue 54 for attaching the trailer 50 to a towing vehicle.

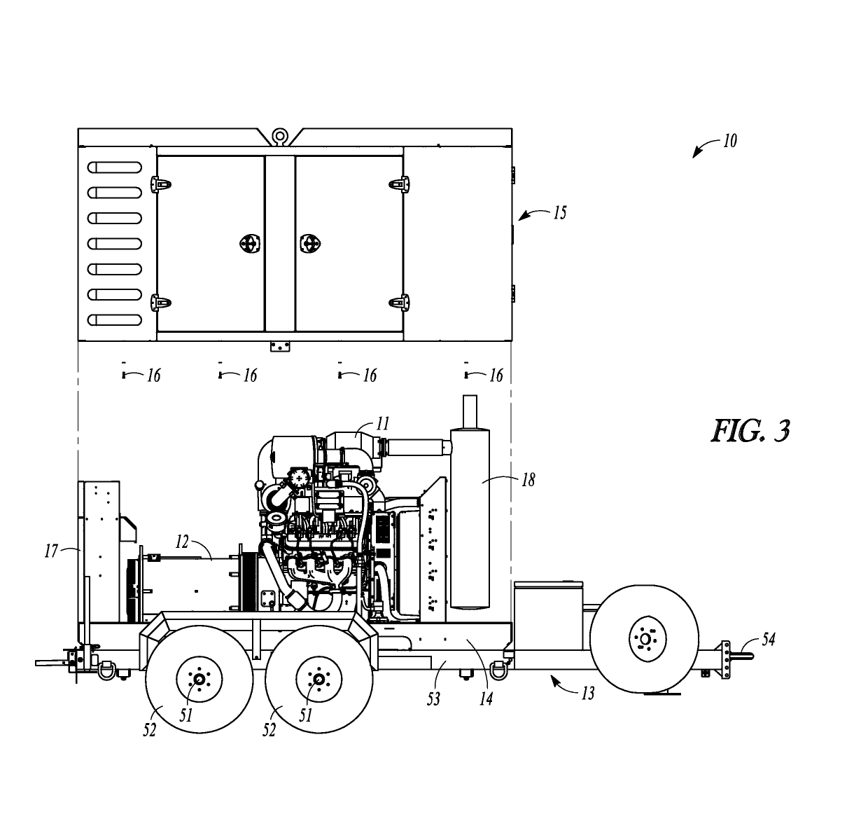

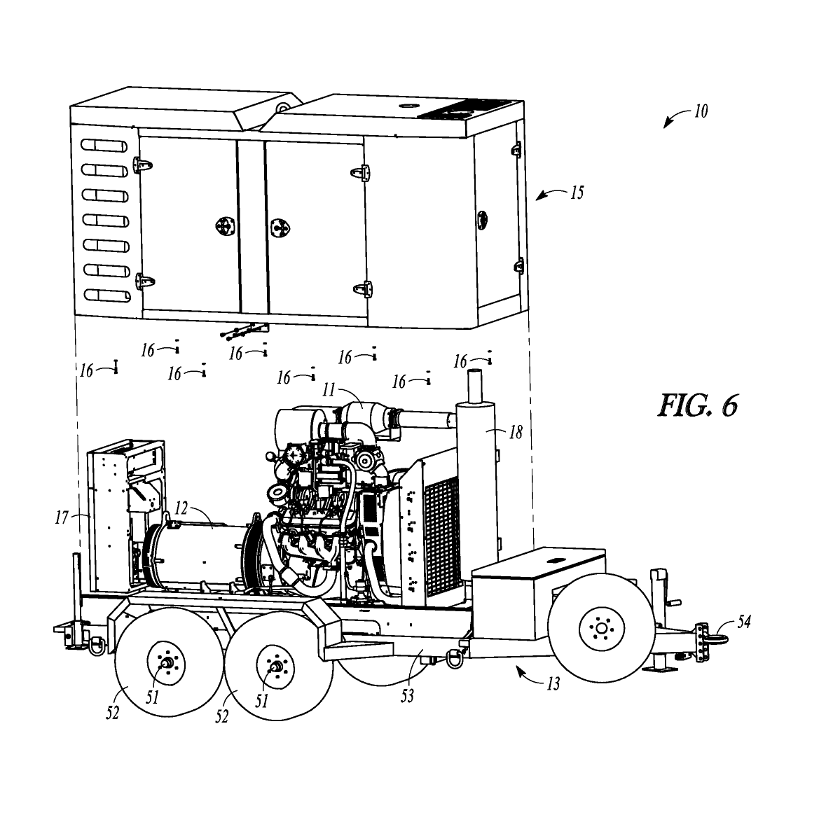

An enclosure 15 houses the internal combustion engine 11 and the alternator 12. The enclosure 15 is detachably connected to the base 14 using fasteners 16 (see, e.g., FIGS. 3 and 6) such that when the fasteners 16 are removed only the enclosure 15 is removed from the base 14 and every other part of the towable generator system 10 remains in place. It should be noted that the enclosure 15 may be formed as one-piece, or be formed of multiple components that are secured together to form a single enclosure. It should be noted that embodiments are contemplated where the enclosure 15 is removed from the base as one piece (see, e.g., FIGS. 3 and 6).

In the illustrated example embodiments, the fasteners 16 are bolts that are removed to permit removal of the enclosure 15 from the base 14. It should be noted while the illustrated example embodiments illustrate the fasteners 16 as being bolts, any type of fastener (or combination of fasteners) that is known now or discovered in the future may be utilized in the towable power generation system 10 including, but not limited to, clamps, snaps, screws and rivets (among others).

The towable power generation system 10 may further include a control panel 17 that is attached to the base 14. In some embodiments, the control panel 17 includes wires (not shown) that provide signals and power to other parts of the towable power generation system 10.

The control panel 17 remains in place when the enclosure 15 is removed from the base 14. In addition, the enclosure 15 may be removed from the base 14 such that no wires need to be disconnected from the control panel 17 when the enclosure 15 is removed from the base 14.

In the illustrated example embodiments, the towable power generation system 10 further includes an exhaust system 18 that is attached to the internal combustion engine 11 to expel gases that are produced by the internal combustion engine 11 from the enclosure 15 when the enclosure 15 is attached to the base 14. In some embodiments, the exhaust system 18 is not attached to the enclosure 15 such that the exhaust system 18 remains in place when the enclosure 15 is removed from the base 14. It should be noted that embodiments are contemplated where any combination of the internal combustion engine 11, the alternator 12 and the exhaust system 18 are able to operate when the enclosure 15 is removed from the base 14.

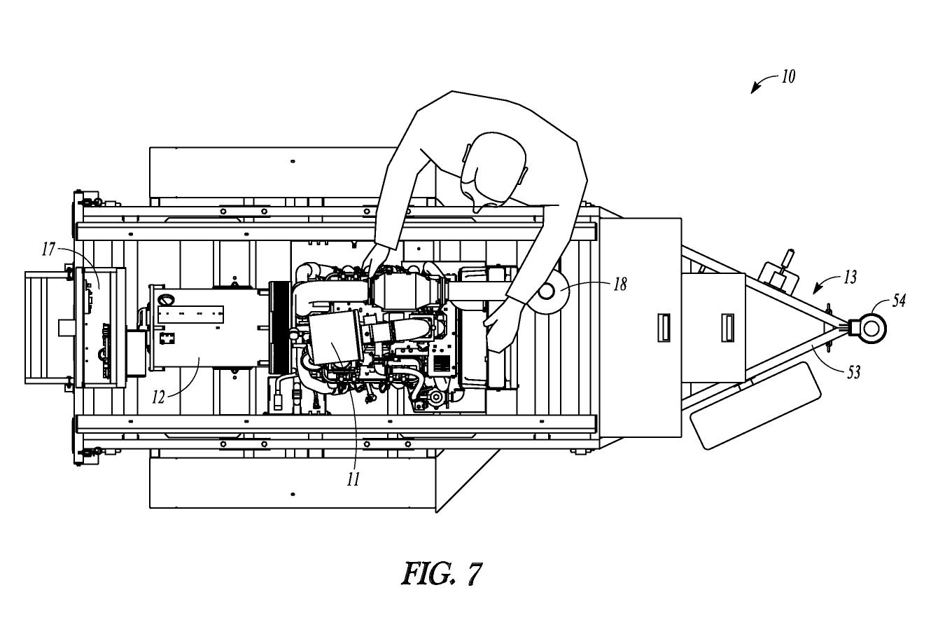

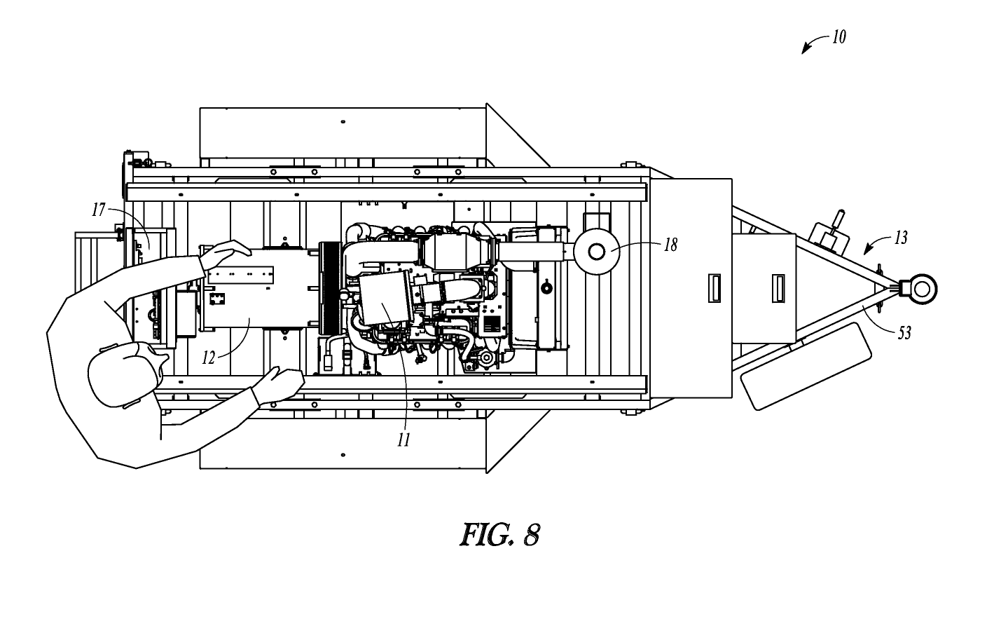

As shown in FIGS. 7 and 8, the base 14 has a perimeter such that in some embodiments a user has access to each part of the towable power generation system 10 from around the entire perimeter of the base 14 when the enclosure 15 is removed from the base 14. FIG. 7 shows the user with access to the internal combustion engine 11, and FIG. 8 shows the user with access to the alternator 12.

The towable power generation systems 10 described herein may allow an entire enclosure to be readily removed from the rest of the towable power generation systems 10. The towable power generation systems 10 may also be able to provide ready access to portions of the internal combustion engine and/or the electrical alternator for repair or replacement when the enclosure is removed. In addition, the enclosure may be removed from the rest of the towable power generation system 10 without extensive disassembly of other components that form the towable power generation system 10.

The Abstract is provided to comply with 37 C.F.R. Section 1.72(b) requiring an abstract that will allow the reader to ascertain the nature and gist of the technical disclosure. It is submitted with the understanding that it will not be used to limit or interpret the scope or meaning of the claims. The following claims are hereby incorporated into the detailed description, with each claim standing on its own as a separate embodiment.

1. A towable power generation system comprising:
an internal combustion engine;
an alternator driven by the internal combustion engine to generate electrical power;
a trailer configured to be attached to a vehicle that is adapted to tow the trailer;
a base attached to the trailer such that the internal combustion engine and the alternator are mounted on the base; and
an enclosure that houses the internal combustion engine and the alternator, wherein the enclosure is detachably connected to the base using fasteners such that when the fasteners are removed only the enclosure is removed from the base and every other part of the towable generator remains in place, wherein the enclosure is removed from the base as one piece, wherein the base has a perimeter such that a user has access to each part of the towable generator from around the entire perimeter of the base when the enclosure is removed from the entire perimeter of the base.

2. The towable power generation system of claim 1, wherein the enclosure is formed of multiple components that are secured together to form the one piece.

3. The towable power generation system of claim 1, wherein the trailer includes at least one axle, at least one pair of wheels, a frame and a tongue adapted to attach the trailer to a moving vehicle.

4. (canceled)

5. A towable power generation system comprising an internal combustion engine;
an alternator driven by the internal combustion engine to generate electrical power;
a trailer configured to be attached to a vehicle that is adapted to tow the trailer;
a base attached to the trailer such that the internal combustion engine and the alternator are mounted on the base; and
an enclosure that houses the internal combustion engine and the alternator, wherein the enclosure is detachably connected to the base using fasteners such that when the fasteners are removed only the enclosure is removed from the base and every other part of the towable generator remains in place, wherein the towable generator further includes a control panel that is attached to the base, wherein the control panel includes wires that provide signals and power to other parts of the towable generator, wherein the control panel remains in place when the enclosure is removed from the base.

6. The towable power generation system of claim 5, wherein no wires need to be disconnected when the enclosure is removed from the base.

7. The towable power generation system of claim 1, wherein the towable generator further includes an exhaust system that is attached to the internal combustion engine to expel gases from the enclosure when the enclosure is attached to the frame.

8. The towable power generation system of claim 7, wherein the exhaust system is not attached to the enclosure.

9. The towable power generation system of claim 7, wherein the exhaust system remains in place when the enclosure is removed from the base.

10. The towable power generation system of claim 1, wherein the fasteners are bolts.

11. The towable power generation system of claim 1, wherein the internal combustion engine and the alternator are able to operate when the enclosure is removed from the base.

12. The towable power generation system of claim 11, further comprising an exhaust system attached to the internal combustion engine, wherein the internal combustion engine, the exhaust system and the alternator are able to operate when the enclosure is removed from the base.

13. (canceled)

14. (canceled)

15. A towable power generation system comprising:
an internal combustion engine;
an alternator driven by the internal combustion engine to generate electrical power;
a trailer configured to be attached to a vehicle that is adapted to tow the trailer;
a base attached to the trailer such that the internal combustion engine and the alternator are mounted on the base; and
an enclosure that houses the internal combustion engine and the alternator, wherein the enclosure includes four side walls and a top wall, wherein the enclosure is detachably connected to the base using fasteners such that when the fasteners are removed only the enclosure is removed from the base and every other part of the towable generator remains in place, wherein the enclosure is removed from the base as one piece.

16. The towable power generation system of claim 15, wherein the base has a perimeter such that a user has access to each part of the towable generator from around the entire perimeter of the base when the four side walls enclosure are removed from the entire perimeter of the base
